(19) United States
(12) Patent Application Publication
(10) Pub. No.: US 2024/0403065 A1
(43) Pub. Date: Dec. 5, 2024

(54) PARALLELIZED BOOT SEQUENCE

(71) Applicant: Advanced Micro Devices, Inc., Santa Clara, CA (US)

(72) Inventors: Sriram Sambamurthy, Austin, TX (US); Indrani Paul, Austin, TX (US); Kevin M. Brandl, Austin, TX (US); James R. Magro, Austin, TX (US); Zhao Hui Yu, Austin, TX (US); Oswin E. Housty, Austin, TX (US)

(73) Assignee: Advanced Micro Devices, Inc., Santa Clara, CA (US)

(21) Appl. No.: 18/680,644

(22) Filed: May 31, 2024

Related U.S. Application Data
(60) Provisional application No. 63/505,125, filed on May 31, 2023.

(51) Int. Cl. G06F 9/4401

(52) U.S. Cl. CPC G06F 9/4411

(57) ABSTRACT

The disclosed device includes multiple special purpose processors that are configured to perform, in parallel, a power on transition sequence for the device, which can involve restoring a data state of components of the device using data stored in local storages of the special purpose processors. Various other methods, systems, and computer-readable media are also disclosed.

### CROSS REFERENCE TO RELATED APPLICATION

This application claims the benefit of U.S. Provisional Application No. 63/505,125, filed 31 May 2023, the disclosure of which is incorporated, in its entirety, by this reference.

### BACKGROUND

During a boot sequence of a computing device, various device interface controllers, such as DRAM controllers for DRAM memory, undergo training for data signal integrity. The training results are often stored such that on subsequent boots or power on transitions, the training results can be restored to avoid the training process. However, this restore process often occurs serially such that the device interface controllers are restored one at a time across all device interface controllers.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for a parallelized boot sequence.

FIG. 2 is a block diagram of an exemplary architecture for a parallelized boot sequence.

FIG. 3 is a block diagram of another exemplary architecture for a parallelized boot sequence.

FIG. 4 is a flow diagram of an exemplary method for a parallelized boot sequence.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to a parallelized boot sequence. As will be explained in greater detail below, implementations of the present disclosure utilize a plurality of special purpose processors to perform, in parallel, a power on transition sequence, or at least a portion thereof, for a device. For certain power on transition sequences, multiple components (e.g., device interface controllers) can be restored in parallel using the special purpose processors rather than serially by a general purpose processor to reduce a power on latency. This reduced power on latency further allows more efficient use of low power states, providing improved efficiency and reduced power consumption. In addition, the parallelized boot sequence can be used for other power on transition sequences, such as restoring a processor's cache.

In one implementation, a device for a parallelized boot sequence includes a plurality of special purpose processors configured to perform, in parallel, a power on transition sequence for the device.

In some examples, the power on transition sequence corresponds to restoring previously-cached data of a cache of a general purpose processor of the device. In some examples, each of the plurality of special purpose processors includes a local storage for storing a portion of the cached data.

In some examples, the device further includes a plurality of device interface controllers, wherein each of the plurality of special purpose processors are configured to perform, in parallel, the power on transition sequence for at least one of the plurality of device interface controllers. In some examples, the power on transition sequence corresponds to restoring previously-trained operational parameters for the plurality of device interface controllers. In some examples, each of the plurality of special purpose processors includes a local storage for storing the previously-trained operational parameters. In some examples, each of the plurality of special purpose processors are configured to perform, in parallel, a boot training sequence for determining operational parameters for the plurality of device interface controllers.

In some examples, the power on transition sequence corresponds to a device boot sequence. In some examples, the power on transition sequence corresponds to exiting a low power state.

In one implementation, a system for a parallelized boot sequence includes a physical memory, at least one physical general purpose processor, a plurality of special purpose processors each including a local storage, and a control circuit configured to coordinate each of the plurality of special purpose processors to perform, in parallel, a power on transition sequence for the system using data stored in the local storage.

In some examples, the power on transition sequence corresponds to restoring previously-cached data of a cache of a general purpose processor and the data stored in the local storage corresponds to a portion of the cached data. In some examples, the system further includes a plurality of device interface controllers, wherein the control circuit further configured to coordinate each of the plurality of special purpose processors to perform, in parallel, the power on transition sequence for at least one of the plurality of device interface controllers.

In some examples, the power on transition sequence corresponds to restoring previously-trained operational parameters for the plurality of device interface controllers and the data stored in the local storage corresponds to the previously-trained operational parameters. In some examples, the control circuit is further configured to coordinate each of the plurality of special purpose processors to perform, in parallel, a boot training sequence for determining operational parameters for the plurality of device interface controllers.

In some examples, the plurality of device interface controllers correspond to at least one of a memory interface or an input/output interface. In some examples, the power on transition sequence corresponds to a device boot sequence. In some examples, the power on transition sequence corresponds to exiting a low power state.

In one implementation, a method for a parallelized boot sequence includes (i) receiving an indication to initiate a power on transition sequence for a device, (ii) coordinating a plurality of special purpose processors to perform, in parallel, the power on transition sequence, and (iii) restoring a state, in parallel by each of the plurality of special purpose processors as part of the power on transition sequence, using data stored in a local storage of each of the plurality of special purpose processors.

In some examples, the power on transition sequence corresponds to restoring previously-cached data of a cache of a general purpose processor and the data stored in the local storage corresponds to a portion of the cached data. In some examples, the power on transition sequence corresponds to restoring previously-trained operational parameters for a plurality of device interface controllers and the data stored in the local storage corresponds to the previously-trained operational parameters.

Features from any of the implementations described herein can be used in combination with one another in accordance with the general principles described herein. These and other implementations, features, and advantages will be more fully understood upon reading the following detailed description in conjunction with the accompanying drawings and claims.

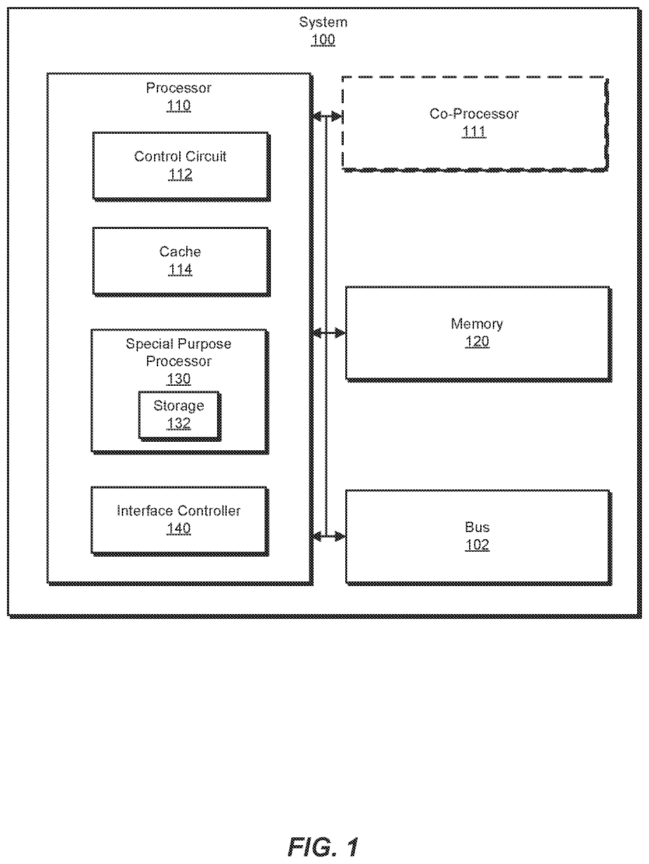

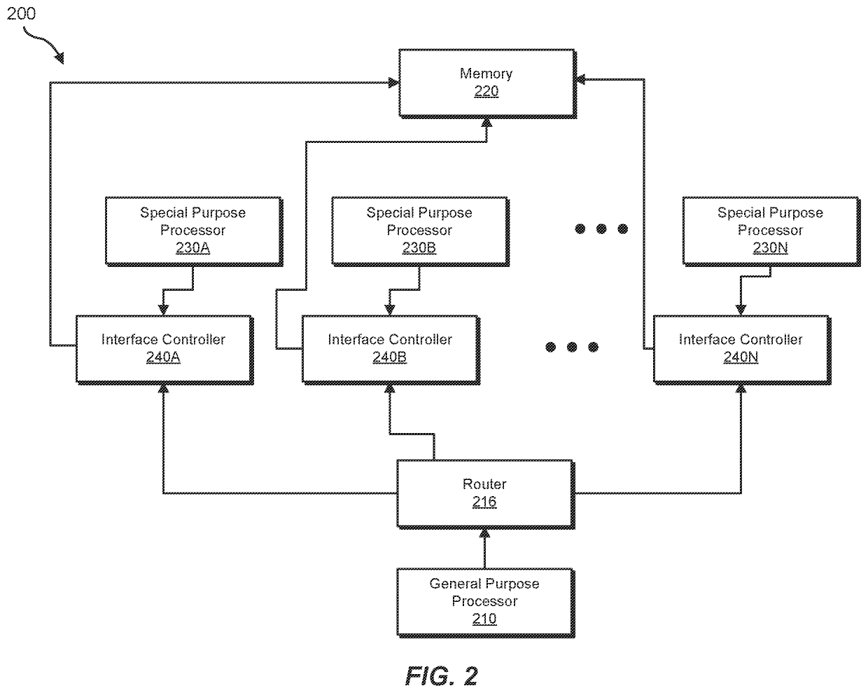

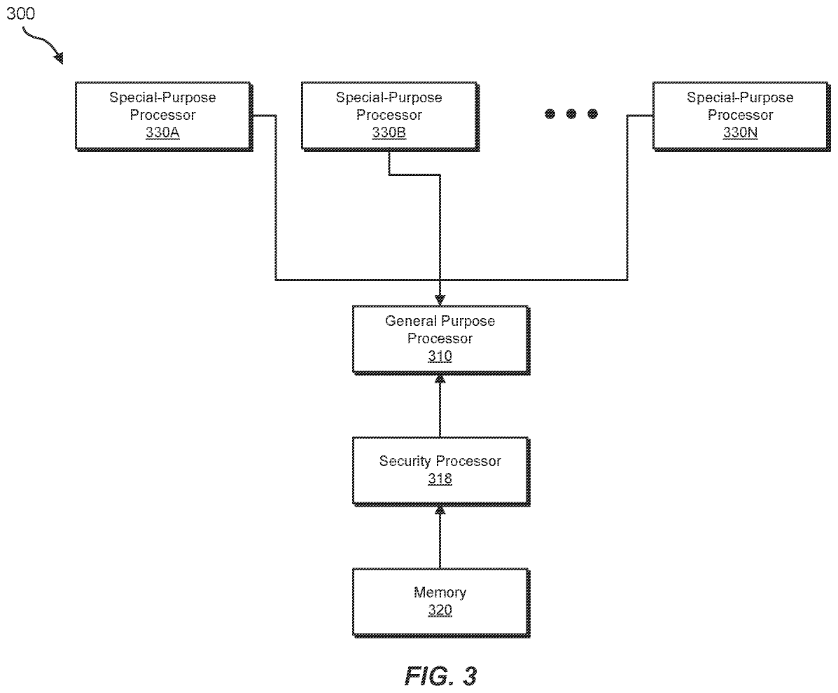

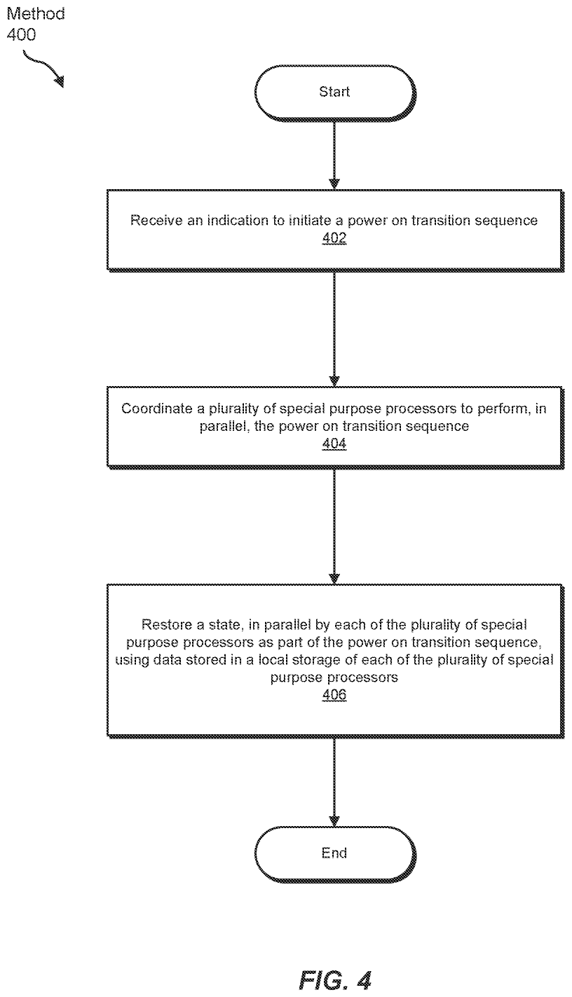

The following will provide, with reference to FIGS. 1-4, detailed descriptions of a parallelized boot sequence. Detailed descriptions of example systems, architectures, and/or circuits will be provided in connection with FIGS. 2 and 3. Detailed descriptions of corresponding methods will also be provided in connection with FIG. 4.

FIG. 1 is a block diagram of an example system 100 for a parallelized boot sequence. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor(s).

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100.

As further illustrated in FIG. 1, processor 110 includes a control circuit 112, and a cache 114. Control circuit 112 corresponds to one or more controllers or other circuitry and/or instructions for coordinating or managing at least a portion of a power on (e.g., wake up) transition sequence. Cache 114 corresponds to a local storage of processor 110 for holding data for processing to avoid costly accesses to memory 120 and can in some examples, correspond to a cache hierarchy of various cache sizes and speeds.

Moreover, FIG. 1 further illustrates a special purpose processor 130 and an interface controller 140. Special purpose processor 130 can correspond to a special purpose processor that, in contrast to a general purpose processor such as processor 110, can be designed for or otherwise limited to specific computing tasks, which in some implementations can correspond to a reduced instruction set or other features. In some examples, special purpose processor 130 can be more efficient and/or consume less resources for performing the specific computing task than processor 110. Special purpose processor 130 further includes a storage 132 corresponding to a local memory device, register, cache, etc. for special purpose processor 130 to locally store data. Although FIG. 1 illustrates a single iteration of special purpose processor 130, in other examples system 100 can include multiple iterations of special purpose processor 130, each having storage 132, and further can each correspond to different types of computing tasks.

Interface controller 140 corresponds to a controller or other control circuit, circuitry, and/or instructions for managing an interface to a device, such as memory 120 or other memory (e.g., more specifically a physical layer thereof), an input/output (I/O) device, or other device. Although FIG. 1 illustrates a single iteration of interface controller 140, in other examples system 100 can include multiple iterations of interface controller 140, each corresponding to the same or different devices.

Interface controller 140 can be configured with parameters for managing the corresponding interface. In some examples, interface controller 140 can be a controller for the interface with memory 120 and can be trained, such as during a boot sequence of system 100, with operational parameters for memory 120, such as parameters relating to tuning signals for noise for a particular memory frequency, voltage controls, timing controls, read/write margins, signal integrity parameters, etc. During certain low power states, interface controller 140 can be powered off such that interface controller 140 does not retain the operational parameters. Thus, powering off and subsequently powering back on interface controller 140 can include a save/restore process in which the operational parameters are stored elsewhere and restored to interface controller 140.

In other examples, interface controller 140 can be a controller for the I/O interface with an I/O device and can also be trained, such as during a boot sequence of system 100 and/or when the I/O device is attached or otherwise enabled, with operational parameters (e.g., voltage controls, timing controls, initialization parameters, signal integrity parameters, etc.). Thus, powering on interface controller 140 can include training the operational parameters, which in some examples can also be saved elsewhere and restored.

FIG. 2 illustrates a system 200 that can correspond to system 100. FIG. 2 illustrates multiple special purpose processors such as a special purpose processor 230A, a special purpose processor 230B, to a special purpose processor 230N, each corresponding to an iteration of special purpose processor 130. FIG. 2 also includes multiple interface controllers such as an interface controller 240A, an interface controller 240B, to an interface controller 240N, each corresponding to an iteration of interface controller 140. The multiple interface controllers can be connected to a memory 220 (corresponding to memory 120 and in some examples is a main memory device such as DRAM) via separate channels, as shown in FIG. 2. FIG. 2 also illustrates a general purpose processor 210, which corresponds to processor 110, and a router 216 corresponding to circuitry for routing data, instructions, and/or other signals to/from general purpose processor 210 (e.g., corresponding to portions of bus 102).

As described herein, when entering a low power state, the interface controllers (e.g., interface controllers 240A-240N) can be powered down, losing previously-trained operational parameters such that the interface controllers can require retraining and/or restoring of the operational parameters. In one example, general purpose processor 210 can, as part of a power on transition sequence (e.g., exiting a low power state), perform the retraining and/or restoring of the previously-trained operational parameters. As general purpose processor 210 can be limited to a single task at a time or otherwise limited to interfacing with a single interface controller at a time, general purpose processor 210 can, via router 216, perform the restore and/or retrain operation on each of the interface controllers one at a time, in a serial fashion. Although multiple interface controllers provide improved performance, with a growing number of interface controllers, this serial restoring can become prohibitive, significantly adding to a power on latency which can negatively affect user experience (e.g., as a user must wait through the power on latency).

The systems and methods described herein provide for parallelizing at least this aspect of the power on transition sequence. Each of the special purpose processors (e.g., special purpose processors 230A-230N) can, as part of a power down transition sequence, save in a respective local storage, the previously-trained operational parameters from the interface controllers. For example, as part of the power down transition sequence as initiated by a power management controller, general purpose processor 210 can receive instructions for powering down and accordingly coordinate, via router 216 (although in other examples can be directly without router 216), the special purpose processors such that special purpose processor 230A can save the operational parameters of interface controller 240A, special purpose processor 230B can save the operational parameters of interface controller 240B, special purpose processor 230N can save the operational parameters of interface controller 240N, etc., which can further be performed in parallel (e.g., each of the special purpose processors performing simultaneously or near simultaneously). Thus, for a portion of the power on transition sequence for restoring the previously-trained operational parameters, each of the special purpose processors can restore, in parallel using the data stored in the respective local storage, the previously-trained operational parameters for the corresponding interface controller, reducing the power on latency as compared to the serial process. For example, as part of a power on transition sequence as initiated by the power management controller, general purpose processor 210 can receive instructions for powering on and accordingly coordinate, via router 216 in some implementations, each of the special purpose processors to restore the respective interface controller, which can further be performed in parallel.

In other examples, the power on transition sequence can correspond to a boot sequence for system 200 and/or a device boot sequence for the interface controllers such that the special purpose processors perform, in parallel, a boot training sequence for determining the operational parameters for the interface controllers. Moreover, although FIG. 2 illustrates a one-to-one correspondence between the special purpose processors and the interface controllers, in other examples, other correspondences can be used (e.g., one-to-many such as special purpose processor 230A interfacing serially with interface controller 240A and interface controller 240B via a router, and further each special purpose processor interfacing with a same and/or different number of interface controllers).

FIG. 3 illustrates a system 300 that can correspond to system 100. FIG. 3 illustrates multiple special purpose processors such as a special purpose processor 330A, a special purpose processor 330B, to a special purpose processor 330N, each corresponding to an iteration of special purpose processor 130. FIG. 3 also includes a general purpose processor 310, which corresponds to processor 110 and/or a component thereof, a security processor 318, and a memory 320, which corresponds to memory 120 (which in some examples is a ROM device). Although not shown in FIG. 3, in some examples, security processor 318 can be connected to multiple iterations of general purpose processor 310.

When general purpose processor 310 enters a low power state, general purpose processor 310 can lose data stored in its cache (e.g., cache 114). Thus, a power on transition sequence can include restoring previously-cached data of general purpose processor 310. In some examples, restoring the cache (e.g., from memory 320) can be more efficient (e.g., reduces a latency) for general purpose processor 310 to resume operations rather than rebuilding the cache from empty. To mitigate potential security concerns (e.g., having malicious code/data being inserted into the cache as part of the power on transition sequence and/or memory 320 during a power off/on sequence) security processor 318 can verify the data being restored to the cache. However, security processor 318 can present a bottleneck (e.g., adding to a power on latency) particularly for large caches.

The systems and methods described herein provide for parallelizing at least this aspect of the power on transition sequence. Each of the special purpose processors (e.g., special purpose processors 330A-330N) can, as part of a power down transition sequence, save in a respective local storage, a portion of the cache from general purpose processor 310. For example, as part of the power down transition sequence initiated by a power management controller, general purpose processor 310 can receive instructions to power down and accordingly coordinate (e.g., directly without a router although in other examples can be through a router) the special purpose processors such that special purpose processor 330A can save a first portion of the cache, special purpose processor 330B can save a second portion of the cache, special purpose processor 330N can save a third portion of the cache, etc., which can further be performed in parallel. Thus, for a portion of the power on transition sequence for restoring the cache, each of the special purpose processors can restore, in parallel using the data stored in the respective local storage, the previously-cached data in the cache of general purpose processor 310, reducing the power on latency as compared to using security processor 318. For example, as part of the power on transition sequence initiated by the power management controller, general purpose processor 310 can receive instructions to power on and accordingly coordinate (e.g., directly and/or indirectly through a router) the special purpose processors to restore its cache. Because in some implementations the special purpose processors can be part of, for example, a same system-on-chip as general purpose processor 310, the data can be less susceptible to attack such that security processor 318 is not strictly needed for this sequence.

FIG. 4 is a flow diagram of an exemplary computer-implemented method 400 for a parallelized boot sequence. The steps shown in FIG. 4 can be performed by any suitable circuit and/or system, including the system(s) illustrated in FIGS. 1, 2, and/or 3. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein receive an indication to initiate a power on transition sequence for a device. For example, control circuit 112 receives an indication to initiate a power on transition sequence for system 100.

The systems described herein can perform step 402 in a variety of ways. In one example, the power on transition sequence can correspond to restoring previously-trained operational parameters for a plurality of device interface controllers (e.g., as described in connection with FIG. 2). In another example, the power on transition sequence can correspond to restoring cached data of a cache of a general purpose processor, which in some examples can include parallelizing a restore process normally from a ROM using a security processor (e.g., as described in connection with FIG. 3).

At step 404 one or more of the systems described herein coordinate a plurality of special purpose processors to perform, in parallel, the power on transition sequence for a device. For example, control circuit 112 coordinates multiple iterations of special purpose processor 130 to perform the power on transition sequence for system 100 in parallel.

At step 406 one or more of the systems described herein restore a state, in parallel by each of the plurality of special purpose processors as part of the power on transition sequence, using data stored in a local storage of each of the plurality of special purpose processors. For example, the iterations of special purpose processor 130 can use data stored in respective storage 132 to restore, in parallel, a state of one or more components of system 100.

The systems described herein can perform step 406 in a variety of ways. In one example, the data stored in the local storage corresponds to the previously-trained operational parameters (e.g., as described in connection with FIG. 2). In another example, the data stored in the local storage corresponds to a portion of the cached data (e.g., as described in connection with FIG. 3).

As detailed above, during a boot from a system off state, a memory controller (e.g., DRAM controller) and interface connections (e.g., DDR PHY connections) with the memory must be trained. This training can take a long enough time which can impact a user experience. To improve the user experience, the settings of the memory (DRAM) controller and the (DDR PHY) interface connections can be saved after the first training for each of them. For example, in an architecture having 16 memory controllers and 16 memory interfaces, the corresponding settings can be saved with values obtained from a memory training procedure on the first boot. On subsequent boots, rather than repeating the above process, the setting and values can be restored for both the memory controllers and the interfaces to enable a faster boot. However, this save/restore process is often performed serially.

In addition, when bringing up multiple I/O devices (e.g., PCIe devices) from their low power device states (e.g., a cold state such as a D3 state), a wake up process includes sending a powering up voltage rail followed by a reset de-assertion to train the I/O link between the SoC and the I/O device. Each of the cold devices have their own power and reset controls which typically get excited. This training also takes a long time as strict timing constraints must be satisfied between each step, especially if there are multiple devices on the platform that needs to be brought out from the cold state. With recent progress for power reduction, more devices are kept powered down during sleep state thereby making the wake up of multiple devices essential during wake up. This wake up process is also often performed serially.

The systems and methods provided herein allow these steps to be performed faster using, for example, accelerators or other special purpose processors that are light weight and instanced appropriately in hardware design to handle multiple things in parallel. By not having to support a large instruction set, the accelerators' hardware is optimized to execute their instructions faster. Accordingly, executing parallelized version of boot sequences as described herein can be more efficient, for instance reducing time for loading firmware(s), reducing time for memory training, reducing time for training peripheral device (I/O) interfaces, etc.

In both cases of memory training and I/O (PCIe) training, there are multiple channels between, for example, the SoC and memory that each have to be trained. In one implementation, the accelerators (e.g., mid-level accelerators) are instanced one per memory controller and interface combination. These mid-level accelerators can be specialized processors rather than general-purpose processors having reduced capabilities as well as reduced overhead by not having to support a large instruction set, allowing hardware optimization to execute instructions faster. These mid-level accelerators can accordingly be configured to accelerate training memory (DRAM) controllers. For example, with 16 of these controllers/interfaces, there are 16 accelerators to handle the training on a 1:1 basis, achieving speed up on training or in saving and restoring the context. The accelerators, in this way, provide a solution to improving user experience by removing any serial overhead involved in these processes.

As detailed above, an issue with conventional systems relates to bottlenecks associated with the serial nature of training memory controllers and interface connections. Although systems with fewer (e.g., 2 or 4) DRAM controller/DDR PHY combinations exhibit this bottleneck to a lesser extent, some high-performance systems having greater (e.g., 4× or 8×) DRAM controller/DDR PHY combinations can exhibit more significant bottleneck. As described herein, using mid-level accelerators (e.g., special purpose processors 230A-N in FIG. 2) can speed up the save and restore process of the DRAM controller/DDR PHY combinations (e.g., interface controllers 240A-N in FIG. 2). For example, a system with 16 DRAM controllers and 16 PHY instances, and assuming each PHY requires at least 3× the context restore time (as a controller), a serial process can require at least 64× the context restore time. Using 16 mid-level accelerators can reduce this (e.g., to 32× or better).

Another issue with conventional systems relates to keeping PCIe devices in D3 cold states to further save power. Each PCIe device can have its own controls for power and reset rails, timing restrictions, etc., based on device specifications and/or optimized wake times, such that training these devices can require multiple routines. For example, PCIe devices such as discrete/dedicated graphics processing units (dGPU), non-volatile memory express (NVMe) storage devices, wireless local area network (WLAN) devices, wireless wide area network (WWAN) devices, LAN on Motherboard (LoM) devices, USB over PCIe devices, PCIe chipset bridges, etc., can be in the cold state, increasing a number of links to be trained, and each link having different training times.

A single microcontroller serially performing PCIe training on standby wakeup can be inefficient. For example, timing constraints on PCIe trainings can be stringent, ranging in the order of 10s of μs for some phases to 100s of μs for other phases. By assigning mid-level accelerators (e.g., special-purpose processors 330A-N in FIG. 3) to do the trainings in parallel, the bottleneck on the single microcontroller can be removed. For example, if training 5 devices, serial training can require more than a second for the system to wake up, whereas parallel training can reduce the wake up time to less than half a second. Accordingly, the systems and methods described herein provides a fast efficient solution to the serial training bottlenecks described herein and further reduces power consumption as an idle state (e.g., after completing the trainings) can be reached faster.

As detailed above, the circuits, devices and systems described and/or illustrated herein broadly represent any type or form of computing device or system capable of executing computer-readable instructions, such as those contained within the modules described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the modules and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), systems on a chip (SoCs), digital signal processors (DSPs), Neural Network Engines (NNEs), accelerators, graphics processing units (GPUs), portions of one or more of the same, variations or combinations of one or more of the same, or any other suitable physical processor.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a plurality of special purpose processors configured to perform, in parallel, a power on transition sequence for the device.

2. The device of claim 1, wherein the power on transition sequence corresponds to restoring previously-cached data of a cache of a general purpose processor of the device.

3. The device of claim 2, wherein each of the plurality of special purpose processors includes a local storage for storing a portion of the cached data.

4. The device of claim 1, further comprising a plurality of device interface controllers, wherein each of the plurality of special purpose processors are configured to perform, in parallel, the power on transition sequence for at least one of the plurality of device interface controllers.

5. The device of claim 4, wherein the power on transition sequence corresponds to restoring previously-trained operational parameters for the plurality of device interface controllers.

6. The device of claim 5, wherein each of the plurality of special purpose processors includes a local storage for storing the previously-trained operational parameters.

7. The device of claim 4, wherein each of the plurality of special purpose processors are configured to perform, in parallel, a boot training sequence for determining operational parameters for the plurality of device interface controllers.

8. The device of claim 1, wherein the power on transition sequence corresponds to a device boot sequence.

9. The device of claim 1, wherein the power on transition sequence corresponds to exiting a low power state.

10. A system comprising:
a physical memory;
at least one physical general purpose processor;
a plurality of special purpose processors each including a local storage; and
a control circuit configured to coordinate each of the plurality of special purpose processors to perform, in parallel, a power on transition sequence for the system using data stored in the local storage.

11. The system of claim 10, wherein the power on transition sequence corresponds to restoring previously-cached data of a cache of a general purpose processor and the data stored in the local storage corresponds to a portion of the cached data.

12. The system of claim 10, further comprising a plurality of device interface controllers, wherein the control circuit further configured to coordinate each of the plurality of special purpose processors to perform, in parallel, the power on transition sequence for at least one of the plurality of device interface controllers.

13. The system of claim 12, wherein the power on transition sequence corresponds to restoring previously-trained operational parameters for the plurality of device interface controllers and the data stored in the local storage corresponds to the previously-trained operational parameters.

14. The system of claim 12, wherein the control circuit is further configured to coordinate each of the plurality of special purpose processors to perform, in parallel, a boot training sequence for determining operational parameters for the plurality of device interface controllers.

15. The system of claim 12, wherein the plurality of device interface controllers correspond to at least one of a memory interface or an input/output interface.

16. The system of claim 10, wherein the power on transition sequence corresponds to a device boot sequence.

17. The system of claim 10, wherein the power on transition sequence corresponds to exiting a low power state.

18. A method comprising:
receiving an indication to initiate a power on transition sequence for a device;
coordinating a plurality of special purpose processors to perform, in parallel, the power on transition sequence; and
restoring a state, in parallel by each of the plurality of special purpose processors as part of the power on transition sequence, using data stored in a local storage of each of the plurality of special purpose processors.

19. The method of claim 18, wherein the power on transition sequence corresponds to restoring previously-cached data of a cache of a general purpose processor and the data stored in the local storage corresponds to a portion of the cached data.

20. The method of claim 18, wherein the power on transition sequence corresponds to restoring previously-trained operational parameters for a plurality of device interface controllers and the data stored in the local storage corresponds to the previously-trained operational parameters.
